(19) United States
(12) Patent Application Publication
(10) Pub. No.: US 2007/0204278 A1
(43) Pub. Date: Aug. 30, 2007

(54) Driver services publication

(76) Inventors: Tim O. Radzykewycz, Clearlake Oaks, CA (US); Tadayuki Okada, Alameda, CA (US)

Correspondence Address: FAY KAPLUN & MARCIN, LLP, 15O BROADWAY, SUITE 702, NEW YORK, NY, 10038, US

(21) Appl. No.: 11/361,806

(22) Filed: Feb. 24, 2006

(51) Int. Cl. G06F 9/46

(52) U.S. Cl. 719/321

(57) ABSTRACT

Described is a system and method for determining a driver method including an identification of the driver method, searching a plurality of instantiated drivers for the identification of the driver method, wherein each of the instantiated drivers publish methods offered by the instantiated driver, each method including the identification and an entry point for the method and accessing the driver method from one of the instantiated drivers including the searched for identification of the driver method.

### BACKGROUND

Current operating systems (OS), particularly Unix-like operating systems such as FreeBSD (Berkeley Software Distribution), make available a limited set of services. However, these services are theoretically limited to kernel modules. Thus, for practical purposes, the services are only made available to the Input/Output system. In other operating systems, such as early versions of VxWorks distributed by Wind River Systems, Inc. of Alameda, Calif., driver methods are utilized in place of services offered by FreeBSD. Driver methods are available for general purpose service publication in that the driver publishes the services it offers and those services may be used by any module resident in the kernel.

However, there was no fixed method for device drivers to let operating systems and middleware modules know of the services that the device driver may provide since they were limited to the kernel modules. The services were made available by the use of “glue code” in each board support package (BSP) in which the device driver was available. The definition of the interface needed to be done in three separate locations: the driver, the BSP, and the OS or middleware module. The current method of publication of driver methods is inefficient because interface definitions must be done in three separate locations and limiting because the glue code must be used to define the available services. Thus, there is a need to develop an efficient method that allows for device drivers and middleware modules, in addition to kernel modules, to obtain a publication of the services offered by another device driver.

### SUMMARY OF THE INVENTION

A method for determining a driver method including an identification of the driver method, searching a plurality of instantiated drivers for the identification of the driver method, wherein each of the instantiated drivers publish methods offered by the instantiated driver, each method including the identification and an entry point for the method and accessing the driver method from one of the instantiated drivers including the searched for identification of the driver method.

A system having a memory storing a set of instructions and a processor executing the set of instructions. The set of instructions being configured to determine a driver method including an identification of the driver method, search a plurality of instantiated drivers for the identification of the driver method, wherein each of the instantiated drivers publish methods offered by the instantiated driver, each method including the identification and an entry point for the method and access the driver method from one of the instantiated drivers including the searched for identification of the driver method.

A system having a hardware device and a device driver including at least one driver method to access the hardware device, the device driver publishing a searchable list of driver methods provided by the device driver, the searchable list including an identification and an entry point for each of the driver methods.

A system having a processor and a device driver including at least one driver method to access a hardware device, the device driver publishing a searchable list of driver methods provided by the device driver, the searchable list including an identification and an entry point for each of the driver methods.

### BRIEF DESCRIPTION OF THE DRAWINGS

FIG. 1 shows an exemplary system for a publication of driver methods on which the present invention may be implemented.

FIG. 2 shows an exemplary system for searching a driver method publication according to the present invention.

FIG. 3 shows an exemplary method for calling a subroutine entry point according to the present invention.

### DETAILED DESCRIPTION

The present invention may be further understood with reference to the following description and the appended drawings, wherein like elements are referred to with the same reference numerals. The exemplary embodiment of the present invention describes a method for publishing driver services. The publication and driver services will be discussed in detail below.

Driver services are different services offered by a driver. The driver is a computer program that enables another program, typically an operating system, to interact with a hardware device. The services that may be offered depend on the type of hardware device that is associated with the driver (e.g., printers may have different print options such as style and color, network cards may have different options such as connecting to TCP/IP protocol, AppleTalk, or other networking protocols, serial channels may have different options such as connecting to a specific channel name such as “COMA:” or “ttyS0”, etc.).

The hardware device may be any type of hardware device such as printers, video adapters, network cards, sound cards, DMA (Direct Memory Access) controller devices, bus controller devices or other device managing any computer interconnect, timer devices, serial channel devices, peripheral devices providing RAM (Random Access Memory), flash memory devices, devices providing NVRAM (Non-Volatile RAM), another processing device (e.g. DSP (Digital Signal Processor), FPGA (Field Programmable Gate Array), standard CPU (both CISC and RISC) processor types, etc.), disk device, network adapter device, wireless devices, tape drives or other disk-backup devices, video adapter devices, sound adapter devices, microphone adapter devices, keyboard devices, mouse devices, peripheral devices controlling lab equipment, manufacturing equipment, or other equipment external to the computer, etc. It is also suitable for multi-function devices, which combine several types of the above (or other) functionality into a single device. Those of skill in the art will understand that the previous list is not exhaustive and there may be many other types of hardware devices that have associated device drivers. Thus, throughout this description, it should be understood that the term hardware device includes any type of hardware device, even where specific examples of devices are provided.

Publication of driver services involves listing different services that the driver offers of which those services may be used by any module resident in a particular kernel (e.g., VxWorks kernel). The kernel is the core of an operating system that is a piece of software responsible for providing secure access to a machine's hardware and to various computer processes (e.g., a computer program in a state of execution). The kernel is also responsible for deciding when and how long a program should be able to make use of a piece of hardware (i.e., scheduling). The module is an object file that contains code to extend the running kernel (i.e., base kernel). Typically, modules are used to add support for new hardware (i.e., physical components of an electronic computing machine), file systems (i.e., method for storing and organizing computer files and the data contained to allow finding and accessing them), or for adding system calls (i.e., mechanism used by an application program to request service from an operating system or a kernel).

In the exemplary embodiments, the exemplary publication of driver services occurs within an electronic computing device. In particular, VxWorks will be used as the basis for the exemplary embodiments. However, it should be noted that VxWorks is only exemplary and that other operating systems may be used (e.g., FreeBSD, Windows, etc.). It should be noted that it will be assumed that the electronic computing devices already contain the necessary devices and corresponding device drivers that are used for publishing the driver services.

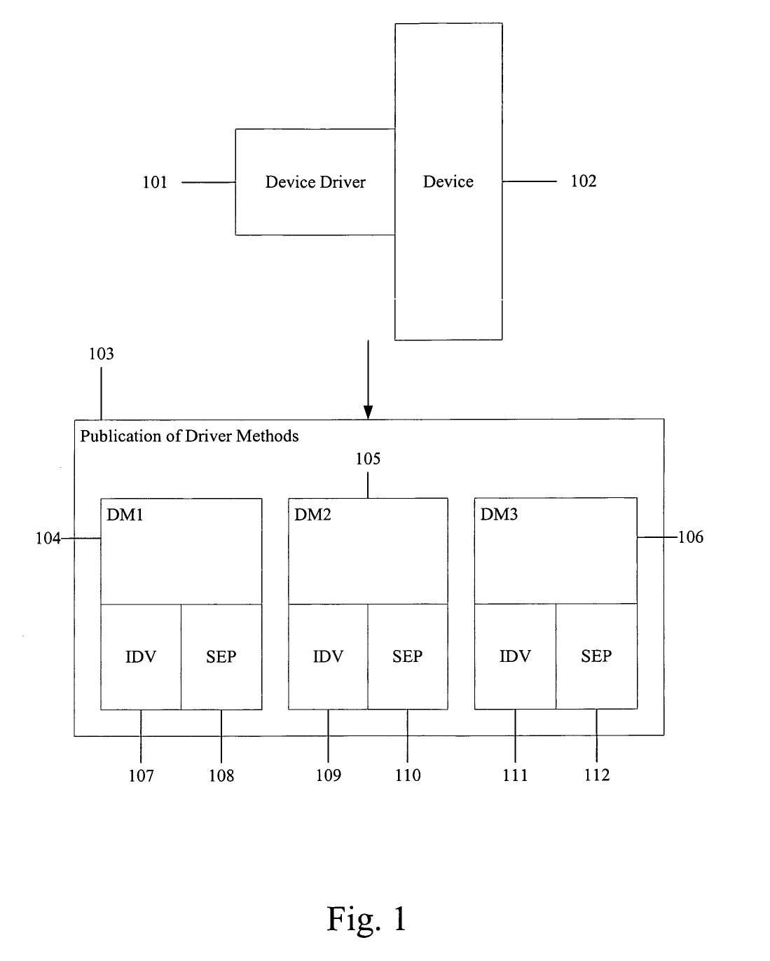

FIG. 1 shows an exemplary system 100 for a publication of driver methods on which the present invention may be implemented. The system 100 includes a device driver 101. The device driver 101 is paired with a corresponding device 102. As discussed above, the device driver 101 is used to connect the device 102 with another program, such as an operating system. The device driver 101 also contains different services to be offered to the other programs that may be done with the device 102. It should be noted that the device driver 101 must be paired with the corresponding device 102 in order for the pairing to function.

The pairing of the device driver 101 with a device 102 results in a publishing of a set of driver methods 103 (i.e., services). The driver methods (DM) are services offered by the driver with additional features, such as general-purpose service publication. Thus, driver methods may be accessed by other devices (e.g., middleware modules, other device drivers) upon publication.

The set of driver methods 103 may include many different driver methods (e.g., DM1 104, DM2 105, DM3 106). Each DM includes an identification value (IDV) (e.g., IDV 107, IDV 109, IDV 111) and a subroutine entry point (SEP) (e.g., SEP 108, SEP 110, SEP 112). The identification value is used to distinguish one driver method from another. Thus, each DM contains a unique IDV. The subroutine is a portion of code within a larger program (e.g., driver) that performs a specific task (e.g., initiating the service) and is relatively independent of the remaining code. The SEP in particular is the portion of code associated with initiating the DM to provide one of the services offered.

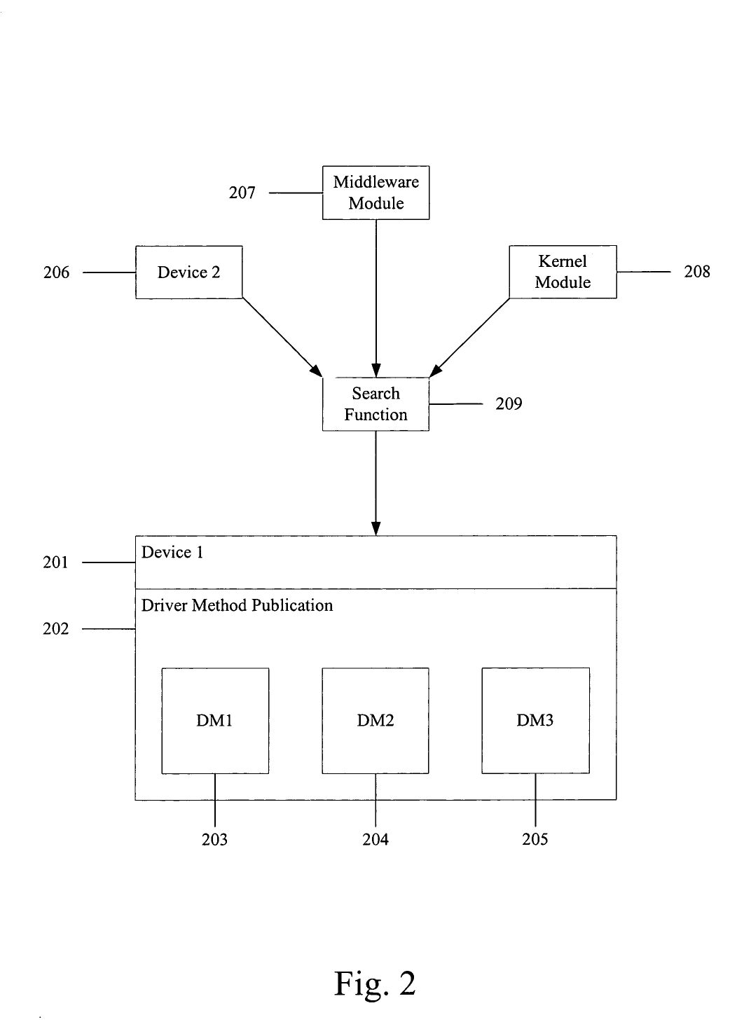

FIG. 2 illustrates an exemplary system 200 of searching a driver method publication that allows further availability beyond kernel modules (e.g., middleware drivers, other device drivers) according to the present invention. As discussed above, a device1 201 contains a driver method publication (DMP) 202 that further contains different DMs (e.g., DM1 203, DM2 204, DM3 205). Prior methods of service offerings were limited to kernel modules (i.e., services made available to Input/Output system only) (e.g., kernel module 208). However, the present invention allows other device drivers (e.g., device2 206) and middleware modules (e.g., middleware 207) to access driver method publications (e.g., DMP 202) of the device (e.g., device1 201).

For example, if a device2 206 requires a DM, device2 206 may search through its own DMP or may access the DMP 202 of device1 201 via search function 209. Through implementation of various properties of the DMs (e.g., IDV, SEP), the device2 206 may locate and utilize a DM of the device1 201 if that DM is what device2 206 is attempting to find. Those of skill in the art will understand that device2 206 searching the DMP 202 of device1 201 is only exemplary and that device2 206 may search other DMPs of other devices. Thus, it is not limited to searching through the DMP 202 of device1 201.

As another example, middleware 207 may also access the DMP 202 of device1 201 if it required a DM via search function 209. The middleware 207 utilizes a common access scheme as described above for device2 206. It should be noted that the present invention still allows kernel modules to access the DMP 202 as illustrated by kernel module 208 in FIG. 2. The method of how the search function operates will be discussed in detail below.

Each device has a DMP for each DM contained within it. Thus, it is more likely that a DMP from one device is different from a DMP of another device. In other words, one device may have a DMP that contains services from one of its DMs that another device may not have in its DMP. Accordingly, one device may retrieve any service or DM from any other accessible device so long as the IDV corresponds to the SEP. It should be noted that the services that are sought may be contained within the device itself and need not access any other device's DMP. In other words, the present invention does not require the device to access other devices in order to perform a certain service. It may access its own kernel module.

Those of skill in the art will understand that a particular DM may use a unique IDV despite other device drivers having an identical DM. Each device driver may desire to distinguish the service it provides regardless of another device having an identical service in order to maintain greater control over which device driver contributes at a given time. It should be noted that if identical services exist among different device drivers, the same IDV may be repeated, depending on the developer of the DMs in order to further reduce development efforts required to implement the present invention.

In addition, the corresponding SEP value assigned may be consistent among different device drivers or it may be unique according to each device driver, despite the DM that is called through the SEP is identical, for the reasons stated above for the DM values. With a consistent value among the different device drivers, a simple solution is possible as one DM will correspond to only one other SEP. When the value of the SEP is unique among the different device drivers, a different system may be incorporated to direct a search function to locate a specific SEP that the IDV is seeking. For example, if a particular DM is found in multiple device drivers but contain different SEP values, the IDV may be programmed to direct the search function to seek the SEP among a group of possible SEP values that all lead to the desired DM. Possible criteria to determine the device driver that is chosen to provide the service include first in time and resource allocation.

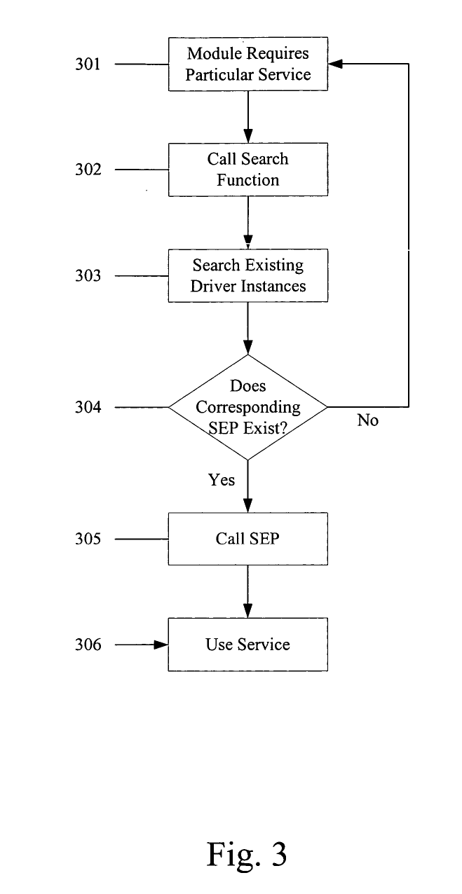

FIG. 3 illustrates an exemplary method 300 for implementing the present invention. The method 300 begins with step 301 when a module (e.g., device2 206, middleware 207) needs to find and use a particular service (e.g., DM1 203, DM2 204, DM3 205). As discussed above, the module is used to extend the running kernel. In the exemplary embodiments, the module does this by finding and using a service. As discussed above, the service to be used by the module is dependent on the device 102 and the proper pairing with the device driver 101.

The method continues with step 302 when the module calls a search function (e.g., search function 209). In step 303, the search function searches through existing driver instances for a specified IDV. The driver instances are a set of one or more regions, belonging to a same driver, that are associated with a particular instance of the driver's device (e.g., device 102). There may be multiple instances of a given driver, one for each physical device controlled or one for each logically separate replication function, as with software only drivers. Each active device node has exactly one corresponding driver instance.

As discussed above, the DM is composed of the IDV and the SEP. The IDV is assigned a particular value that corresponds to a SEP. Thus, when a device is searching for the IDV among different DMPs, only the corresponding SEP may be called (i.e., one IDV is associated with only one SEP). For example, as illustrated in FIG. 1, if a device is searching for the IDV 107, then only SEP 108 may be called and thus DM1 is used. Accordingly, if the IDV 109 or the IDV 111 is sought, then the SEP 110 and the SEP 112 is called, respectively, and DM2 and DM3 are used, respectively. Again, it should be noted that the search within one device driver is exemplary only and that the present invention allows searching through multiple device drivers and modules to find the IDV.

Through composing one DM with a unique IDV and a unique, corresponding SEP, an ad-hoc BSP code (i.e., “glue code”) that was previously required to be present in each BSP is eliminated. This results in a reduction in any development efforts for a device driver and in turn significantly reduces the development effort to port an existing device driver to a BSP on which it has never before been used.

In step 304, if the corresponding SEP does not exist, then the method returns the search of the IDV to the module that requested the particular service. If the corresponding SEP exists, then the method proceeds to step 305. In step 305, the SEP is called and then in step 306, the DM is used to provide the service the module is seeking.

The DMs may be used to offer services to other device drivers that ordinarily were not available. Many new areas of functionality that may be made available to device drivers include making use of general purpose digital media archive devices, making timers available for general purpose use instead of a pre-defined timer functionality that was used in previous versions, and offering special purpose memory devices for general use. Again, it should be noted, as discussed above, the DMs may be used to offer services to middleware modules, in addition to kernel modules and other device drivers. Middleware modules include file systems and network protocols. Services may be offered without the need to know a particular device name.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
determining a driver method including an identification of the driver method;
searching a plurality of instantiated drivers for the identification of the driver method, wherein each of the instantiated drivers publish methods offered by the instantiated driver, each method including the identification and an entry point for the method; and
accessing the driver method from one of the instantiated drivers including the searched for identification of the driver method.

2. The method of claim 1, wherein the accessing the driver method includes receiving the entry point for the driver method from the instantiated driver.

3. The method of claim 1, wherein each instantiated driver is paired with a hardware device and the instantiated driver allows access to the paired hardware device.

4. The method of claim 1, wherein the hardware device is one of a printer, a video adapter, a network card, a sound card and a local bus.

5. The method of claim 1, wherein the method is performed by the one of the instantiated drivers.

6. The method of claim 1, wherein the method is performed by one of a driver, a middleware module and a kernel module.

7. The method of claim 1, wherein the identification of the driver method is unique.

8. The method of claim 1, wherein the driver method is a service offered by the one of the instantiated drivers.

9. A system comprising a memory storing a set of instructions and a processor executing the set of instructions, the set of instructions being configured to:
determine a driver method including an identification of the driver method;
search a plurality of instantiated drivers for the identification of the driver method, wherein each of the instantiated drivers publish methods offered by the instantiated driver, each method including the identification and an entry point for the method; and
access the driver method from one of the instantiated drivers including the searched for identification of the driver method.

10. A system, comprising:
a hardware device; and
a device driver including at least one driver method to access the hardware device, the device driver publishing a searchable list of driver methods provided by the device driver, the searchable list including an identification and an entry point for each of the driver methods.

11. The system of claim 10, wherein the device driver provides the corresponding entry point for one of the driver methods to an entity searching the searchable list for the identification of the one of the driver methods.

12. The system of claim 11, wherein the entity is one of the device driver, another device driver, a middleware module and a kernel module.

13. The system of claim 11, wherein the entity accesses the one of the driver methods in the device driver using the entry point.

14. The system of claim 10, wherein the hardware device is one of a printer, a video adapter, a network card, a sound card and a local bus.

15. The system of claim 10, wherein the identification of each driver method is unique.

16. The system of claim 10, wherein the searchable list is the only publication location of the driver methods for the device driver.

17. The system of claim 10, further comprising:
a search mechanism to search the searchable list for the identifications of the driver methods.

18. The system of claim 10, wherein the driver methods include a timer.

19. A system, comprising:
a processor; and
a device driver including at least one driver method to access a hardware device, the device driver publishing a searchable list of driver methods provided by the device driver, the searchable list including an identification and an entry point for each of the driver methods.

20. The system of claim 19, wherein the device driver provides the corresponding entry point for one of the driver methods to an entity searching the searchable list for the identification of the one of the driver methods.
